(19) United States
(12) Patent Application Publication
(10) Pub. No.: US 2004/0211582 A1
(43) Pub. Date: Oct. 28, 2004

(54) Vehicle component having an electrical conductor adhesively secured into the component

(75) Inventor: Philip Edward Arthur Stuart, Chatham (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive, Inc.

(21) Appl. No.: 10/422,032

(22) Filed: Apr. 23, 2003

(51) Int. Cl. B32B 31/00

(52) U.S. Cl. 174/50; 156/293; 156/303.1; 428/577

(57) ABSTRACT

A vehicle component assembly (20) has a component body (22) that includes a first portion (30) and a second portion (32). A selected section (26) of a wire harness (24) is secured into the component body (22) using an adhesive (28). In one example, the adhesive (28) surrounds the conductor (25) of the wire harness (24). The adhesive (28) secures the component body portions (30) and (32) together.

### CROSS REFERENCE TO RELATED APPLICATIONS

This application claims priority to U.S. Provisional Application No. 60/275,754, which was filed on Apr. 25, 2002.

### BACKGROUND OF THE INVENTION

A variety of devices on vehicles require electrical power and electrical signals for proper operation. Accordingly, there are many electrical conductors strategically positioned to provide proper connectivity with the various components requiring electricity. One challenge facing modern vehicle suppliers and designers is how to effectively and economically integrate an ever-increasing number of electrical conductors into vehicle systems.

A typical approach includes using wiring harnesses that route wires to desired locations on a vehicle. In many instances, wire harnesses must be routed around vehicle components so that appropriate connections can be made. The position of some devices requiring an electrical connection make such routing difficult in many instances. One attempted solution has been to secure a portion of electrical conductors to an exterior or exposed interior surface of a housing of a component associated with the device requiring the electrical connection. Another approach has been to attempt to secure the connector to such a housing during a molding process.

The disadvantage to the exterior connection approach is that it is expensive, operator intensive and does not necessarily provide a secure connection to the device of interest. A significant drawback of the attempt to mold wiring into the component housing is the relatively high scrap rate as a result of molding problems. Additionally, the molding technique is operator intensive, which increases expenses. Further, there are recycling issues presented when an otherwise plastic component has electrical conductors molded into it.

There is a need for an improved way of associating electrical conductors with vehicle component housings. This invention addresses that need.

### SUMMARY OF THE INVENTION

In general terms, this invention is a vehicle component having at least one electrical conductor adhesively secured into the component.

One example component designed according to this invention has a body that includes a first portion secured to a second portion. At least one electrical conductor is positioned at least partially between the first and second body portions. An adhesive secures the conductor to at least one of the body portions.

In one example, the adhesive secures the first portion to the second portion. In a particular example, the adhesive is applied around the conductor which is then placed between the first and second portions. As they are moved into position against each other and as the adhesive cures, they become held together by the adhesive.

In one example, at least one electrical connector is supported by one of the component portions and then glued into place by the same adhesive used to secure the component portions together. In one example, the connector includes a tong that makes a conductive connection with the portion of the connector in the housing.

A method of making a vehicle component designed according to this invention includes securing at least a portion of at least one conductor to at least a first portion of the component using an adhesive. A second portion of the component is secured to the first portion with the conductor between the first and second portions.

In one example, the same adhesive is used to secure the conductor in place and to secure the first and second component portions together.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates an example vehicle component having an electrical conductor integrated into the component according to this invention.

FIG. 2 schematically illustrates an example method of assembling a vehicle component designed according to this invention.

FIG. 3 schematically illustrates another example assembly having an electrical connector supplied by the housing of the component.

FIG. 4 is an exploded, perspective view schematically showing another example component assembly designed according to this invention.

FIG. 5 is an exploded, perspective view schematically showing another example component assembly designed according to this invention.

### DETAILED DESCRIPTION OF THE PREFERRED EMBODIMENTS

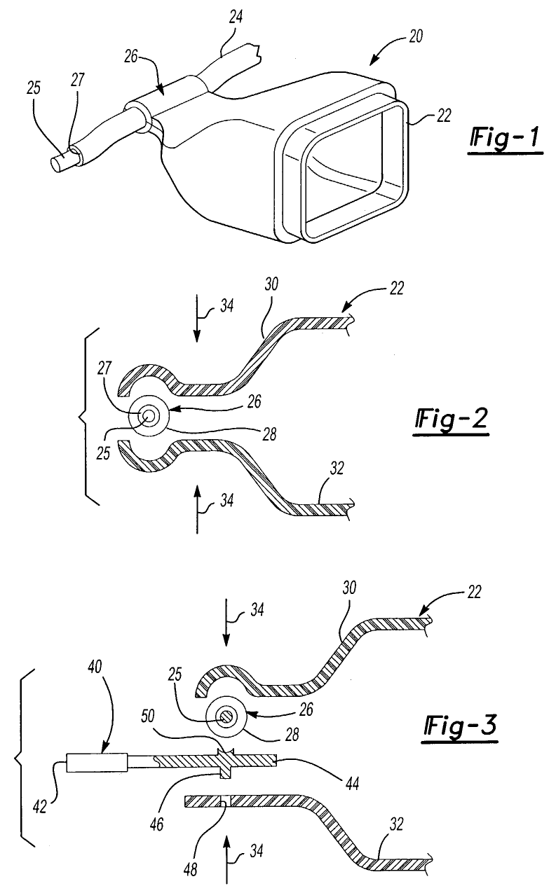

An air intake manifold assembly 20 is schematically shown in FIGS. 1 and 2. The assembly 20 includes a manifold body 22, which is generally configured in a conventional manner to operate as required for the air intake system of a vehicle. An air intake manifold is shown as an example vehicle component. This invention is not limited to air intake manifolds and those skilled in the art who have the benefit of this description will realize the applicability of this invention for various vehicle components such as an air filter housing or an acoustic cover attachment.

A wiring harness 24 includes at least one electrical conductor 25. In the illustrated example, a portion 26 of the wire harness 24 is adhesively secured in a selected position within the component body 22. As best seen in FIG. 2, an insulation layer 27 surrounds the conductor 25. A layer of adhesive 28 encapsulates the insulation layer 27.

In another example, the conductor 25 does not have an exterior insulation layer 27. In such an example, the adhesive 28 preferably has some electrical insulating properties so that appropriate insulation is achieved. Depending on the particular wire harness arrangement and the particular materials of the vehicle component housing, those skilled in the art will be able to select from among commercially available adhesives to meet the needs of a particular situation.

As best appreciated from FIG. 2, the air intake manifold body 22 has a first portion 30 and a second portion 32. The first and second portions are molded in one example using conventional molding techniques and a commercially available plastic material. The wire harness 24 is positioned relative to the first and second portions so that the desired portion 26 is between the first portion 30 and the second portion 32 of the component body 22. As schematically illustrated by the arrows 34 in FIG. 2, the first portion 30 and second portion 32 are brought into contact with each other and held in place until the adhesive 28 secures them together. At the same time, the wire harness 24 is secured in place within the appropriate position within the component body 22.

In some examples, the component portions 30 and 32 will be held together by the adhesive 28. In some situations, an additional securing member holds the pieces together in addition to the adhesive 28. Example securing members include screws, rivets, bolts and locking tabs. Depending on the particular vehicle component, those skilled in the art who have the benefit of this description will realize and be able to select from among conventional securing techniques to use in conjunction with an adhesive associated with the conductor 25 to meet the needs of a particular situation.

The inventive approach allows for conveniently, economically and securely positioning at least a portion 26 of a wire harness 24 in a selected position within a vehicle component body.

In one example, the adhesive 28 encapsulates the appropriate portion 26 of the wire harness 24. In another example, the adhesive 28 is applied to one of the component body portions 30 or 32 and the wire harness is placed onto the adhesive. A variety of adhesives may be used.

This invention provides a variety of advantages including the ability to check the integrity of the wire harness before installation. Connectors for making electrical connection between the wire harness and the devices that require electrical power can be pre-attached and fit into receptacles on the component housing portions, which provides stable connection points. Some devices may be directly attached to the harness before installation into the vehicle component body, which reduces connection joints and introduces further economies during the assembly process. In instances where insulation around a conductor can be eliminated, material savings may be realized.

Another advantage that is realized in some examples is that the adhesive can be dissolved or otherwise treated to separate the component portions to make repairs or replacements to the wire harness or an appropriate portion of the component. This provides possible material and part savings and can simplify a repair procedure.

FIG. 3 shows one example arrangement that is a modification of the embodiment shown in FIG. 2. In this example, a connector 40 includes a receptacle 42 that houses male or female connecting elements as needed for a given situation. The connector 40 has a conductive body portion 44 that is received against the wire harness within the component 20. A positioner 46 is adapted to fit within a receiver (i.e., an opening) 48 on the portion 32 of the component 20.

As the portions 30 and 32 are brought together, the adhesive 28 secures the wire harness portion 26 in place between the component portions. At the same time, a tong 50 on the conductive body portion 40 makes an electrically conductive connection with the conductor 25. In one example, the tong 50 pierces through the insulation layer 27 and contacts the conductor 25.

An embodiment of this invention incorporating such a connector and assembly strategy provides the advantages of minimizing the number of physical connector pieces coupled to the wire harness to achieve a desired number of connections and simplifies the wire harness construction.

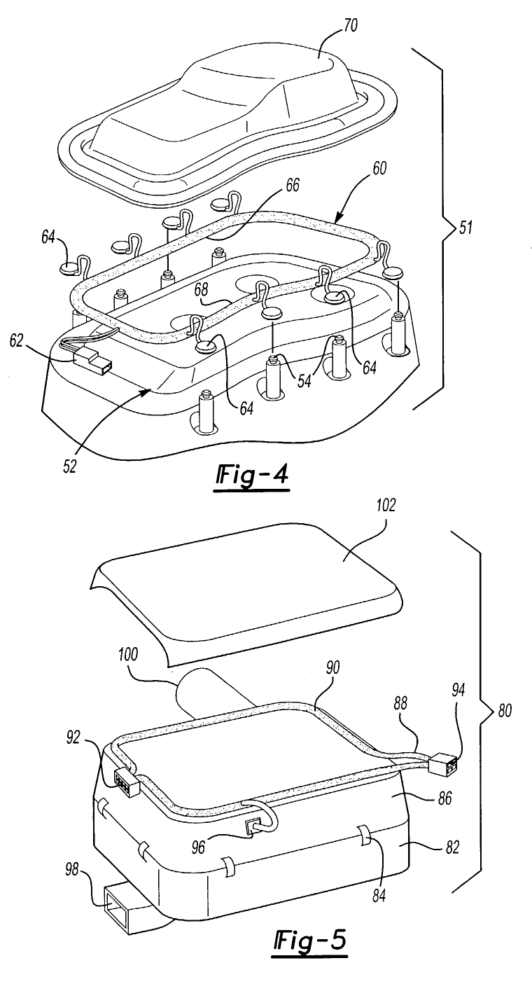

FIG. 4 schematically shows another example component assembly 51 where a manifold 52 supports a plurality of serviceable devices 54 such as fuel injectors, for example. A wire harness 60 has a connector 62 at one end. A plurality of loose connectors 64, which are like the connector 40 in one example, are for making electrical connections between the wire harness 60 and the serviceable devices 54. The conductive wires 66 of the wire harness are encapsulated in an adhesive 68.

A decorative trim cover 70 is secured in place adjacent the manifold 52 by the adhesive 68 when the wire harness 60, manifold 52 and trim cover 70 are brought together and the adhesive 68 sets or is allowed to cure.

FIG. 5 shows another example implementation of this invention. In this example, an air filter assembly 80 includes a housing base 82 that is clipped by clips 84 to another portion 86 in a conventional manner. A wire harness 88 includes an adhesive 90 over a substantial portion. Connectors 92 and 94 facilitate making electrically conductive connections with other wire harnesses or devices associated with the vehicle on which the air filter assembly 80 is provided. A sensor connector 96 facilitates making a connection with a sensor (not illustrated) associated with the fiter.

Ducts 98 and 100 allow unfiltered air to flow into, through and out of the filter assembly 80. A decorative trim cover 102 is secured in place on the assembly by the adhesive 90 that also secures the wire harness in place between the cover 102 and the portion 86.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of assembling a vehicle component, comprising the steps of:
securing at least a portion of at least one conductor to at least a first portion of the component, using an adhesive; and
securing a second portion of the component to the first portion with the portion of the conductor between the first and second portions.

2. The method of claim 1, including using an electrically insulating adhesive to secure the conductor to at least the first portion.

3. The method of claim 1, including securing the first portion to the second portion, using the same adhesive used to secure the conductor to the first portion.

4. The method of claim 1, including securing at least a portion of at least one connector member between the first and second portions and making an electrically conductive connection between the connector member and the conductor.

5. The method of claim 1, including encapsulating at least a portion of the conductor in the adhesive and placing the adhesive in contact with at least the first portion.

6. The method of claim 5, including placing the second portion against the first portion and the adhesive.

7. The method of claim 1, including applying the adhesive to the first portion, placing at least a portion of the conductor in contact with the adhesive and placing the second portion in contact with the first portion.

8. The method of claim 7, including subsequently curing the adhesive.

9. A vehicle component, comprising:
a body having a first portion secured to a second portion;
at least one electrical conductor positioned at least partially between the first and second body portions; and
an adhesive securing the conductor to at least one of the body portions.

10. The component of claim 9, wherein the adhesive secures the first portion to the second portion.

11. The component of claim 9, wherein the adhesive surrounds the conductor.

12. The component of claim 11, wherein the adhesive is electrically insulating.

13. The component of claim 9, wherein the body comprises an air inlet manifold.

14. The component of claim 9, wherein the conductor comprises a wire harness.

15. The component of claim 9, including at least one connector in conductive contact with the conductor, the connector having a portion secured between the body portions.

16. The component of claim 15, wherein the connector includes a tong portion that contacts the conductor.

17. The component of claim 15, wherein the connector includes a positioner and at least one of the body portions has a receiver that receives the positioner.
